(19) United States
(12) Patent Application Publication
(10) Pub. No.: US 2017/0005456 A1
(43) Pub. Date: Jan. 5, 2017

(54) High Efficiency Spark Plug

(71) Applicant: Grigori BROUDNO, Toronto (CA)

(72) Inventor: Grigori BROUDNO, Toronto (CA)

(21) Appl. No.: 14/392,370

(22) PCT Filed: Jul. 8, 2014
(86) PCT No.: PCT/CA2014/000552

§ 371 Date: Feb. 8, 2016

(51) Int. Cl. H01T 13/20

(52) U.S. Cl. CPC H01T 13/20

(57) ABSTRACT

A high efficiency spark plug (10) is provided with three internal chambers (V₁, V₂ and V₃). The middle chamber has side walls surrounding and spaced from the central electrode in a predetermined spaced manner with the side wall serving as the grounding electrode. An upper chamber (V₃) is located above the middle chamber (V₂) and a bottom chamber (V₁,) is located below the middle chamber (V₂). The volumes of the three chambers have the following relationship V₁,+V₂<V₃.

### TECHNICAL FIELD

Spark plugs are the prime components in an internal combustion engine which is for igniting the air and fuel mixture in the engine cylinder for producing the power to operate the engine pistons so as to generate the rotational movement. In the ignition process, a large volume, namely up to 50%, of the air and fuel mixture injected into the engine can remain non-ignited and also the ignited portion of the mixture produces a large amount of waste material including noxious gas, carbon monoxide and other non-ignitable substances. Some of the waste material is discharged into the atmosphere to cause pollution of the latter. Another portion of the residual waste material mixes with the fresh air and fuel mixture subsequently injected into the engine, thus the subsequent air and fuel mixture can be highly polluted with the waste material from the previous ignition process. The polluted mixture reduces the efficiency of the subsequent ignition operation to produce less power output and to produces yet more additional waste material. Therefore more and more waste material is produced in the engine by the ignition process. The accumulating amount of waste material reduces the engine power output and increases the fuel consumption resulting in causing irregular operation of the engine.

Attempts have been made with new spark plug designs with the electrode of the spark plug located within a hollow pre-ignition chamber formed in the spark plug around the electrode. The central electrode and the grounding electrode are recessed and spaced from the lower opening of the pre-ignition chamber. The grounding electrode may also separate the pre-ignition chamber into a lower chamber between the central electrode and the lower opening of the shell of the spark plug and an upper chamber surrounding the insulated portion of the central electrode. Ignition occurs in the lower chamber so that the flame is injected into the cylinder chamber to ignite the air and fuel mixture to reduce the production of waste material less high temperature exposure to the engine components. However, waste material is still produced in the pre-ignition chamber, and the waste material again as in the conventional spark plugs would mix with the fresh air and fuel mixture injected into the engine cylinder chamber to form a concentrated polluted mixture in the pre-ignition chamber to cause unsatisfactory ignition and back fire.

New high efficiency spark plug designs such as that shown in PCT application PCT/CA2013/00xxx by the applicant of the present application have reduced the production of the waste material in the ignition by providing three chambers in the spark plug. The air and fuel mixture injected into the combustion chamber of the engine would enter the lower chamber of the spark plug. The mixture in the lower chamber is ignited by the spark between the central electrode and the grounding electrode surrounding the central electrode. Any unburned material and noxious gases produced in the ignition is mainly confined within the lower chamber of the spark plug. The ignition will cause the air and fuel mixture in the combustion chamber to ignite instantaneously. Subsequent fresh air and fuel mixture injected into the combustion chamber will force the high temperature waste materials and noxious gases, if any, from the lower chamber to flow into the middle chamber above the lower chamber and then into an upper chamber located above the middle chamber. The waste material would remain in the middle and the upper chamber and will not mix with the subsequent fresh air and fuel mixture. Thus, it results in a clean ignition to provide a maximum power output. However, the configuration of the three chambers construction as shown in the above prior art is relatively complex and it still can result in uneven engine operation.

### SUMMARY OF THE INVENTION

It is a principal object of the present invention to provide an improved spark plug design which operates with very high efficiency to provide high engine operation with very low pollution emission.

It is another object of the present invention to provide an improved spark plug having a three-chambers construction capable of reducing the maximum reduction of production of waste material in the ignition operation.

It is yet another object of the present invention to provide an improved spark plug construction which operates to provide high output power of the internal combustion engine.

### BRIEF DESCRIPTION OF THE DRAWINGS

In the drawings,

FIG. 1 is a cross sectional perspective side elevation view of the spark plug of the present invention.

FIG. 2 is a cross sectional perspective side elevation view of the cylindrical body of the spark plug having internal sections of various dimensions.

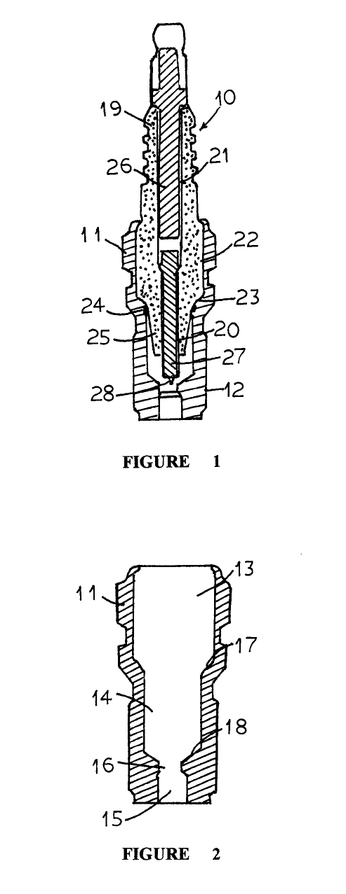

### DETAILED DESCRIPTION OF THE PREFERRED EMBODIMENT

With reference to the drawing, the spark plug 10 of the present invention has a generally cylindrical metal body 11 Threads 12 are formed on the outer surface of the body 11 for mounting the spark plug to an internal combustion engine. As best shown in FIG. 2, various hollow sections 13, 14, 15 and 16 are formed in the body 11. The hollow upper cylindrical section 13 has a larger diameter then the upper middle section 14. The diameter of the hollow bottom section 15 is smaller than the upper middle section 14, and the hollow middle section 16 is smaller in diameter than the bottom section 15. A downwardly sloping convergent shoulder 17 is formed between the upper section 13 and the upper middle section 14, and another downwardly sloping convergent shoulder 18 is preferably formed between the upper middle section 16 and the bottom section 15.

A generally cylindrical ceramic insulator carrier 19 is mounted at the top of the metal body 11. The insulator carrier 19 has a lower internal bore 20 and an upper internal bore 21. The middle portion 22 of the insulator carrier 19 has size and diameter equal to the size and diameter of the upper section 13 of the metal body 11 and a downwardly sloping convergent side wall 23, having the same sloping shape and dimension as the sloping convergent shoulder 17 of the upper section is formed at the bottom portion of the insulation carrier 19 such that the insulator carrier 19 can be intimately and slidably mounted in the upper section 13 of the metal body 11. A copper sealing ring 24 is located at the sloping side wall 23 to ensure an air-tight seal between the insulator carrier 19 and the metal body 11. The insulator carrier 19 has a frusto-conical lower portion 25 extending into the upper middle section 14 of the metal body 11. An electrical conductive metal rod 26 is mounted in the upper internal bore 21. The metal rod 26 has a threaded upper end extending outside the upper end of the insulator carrier 19 for mounting a cap for connection to the electrical supply to the spark plug. A central electrode 27 is mounted in the lower internal bore 20. The spark electrode 28 is located at the bottom end of the central electrode 27 and it extends into the middle section 16 of the body 11 and is positioned in a predetermined spaced manner from the side wall of the middle section 16 which serves as the grounding electrode of the spark plug.

When the insulator carrier 19 is mounted to the metal body 11, a lower chamber having a predetermined volume V₁ is formed in the bottom section 15, and a middle chamber having a predetermined volume V₂ is formed in the middle section 16, and an upper chamber having a predetermined volume V₃ is formed in the upper section 13. The volumes of the three chambers have the relationship according to the following formula:

V₁+V₂≦V₃

The spark electrode 28 located in the middle chamber, is thus recessed from the bottom end opening of the spark plug.

In operation, the ignition occurs in the middle chamber of the spark plug rather than in the combustion chamber of the engine and any residual unburned material and gases in the initial ignition will be confined in the middle chamber and the lower chamber, and as the fresh air and fuel mixture is injected into the combustion chamber of the engine, the new fresh mixture enters into the spark plug to push most of the residual unburned material and gases from the lower chamber and the middle chamber into the upper chamber. Thus, the combustion will be provided by the fresh air and mixture to provide a clean and efficient combustion for the combustion engine. Any small amount of unburned material from the initial ignition will be burned by the efficient combustion. Since the volume of the upper chamber V₃ is larger than the total volume of the volume V₁ of the lower chamber plus the volume V₂ of the middle chamber, it provides a large reservoir to contain the unburned material and gases from each ignition operation. A portion of the unburned material and gases of each ignition operation in the upper chamber is mixed with the subsequent fresh air and fuel mixture in the subsequent ignition, thus it is reduced by the subsequent combustion. Therefore, little or minimal amount of unburned material and/or gases, if any, would be emitted from the exhaust of the engine. Therefore, the relatively simple structure of the spark plug of the present invention provides highly efficient operation to provide smooth engine operation and clean exhaust.

The upper chamber may be formed by a plurality of chambers having a total volume of Vₙ to provide the same result as long as it meet the relationship that V₁+V₂≦Vₙ in which n is the number of upper chambers.

What is claimed is:

1. A high efficiency spark plug comprising:
a metal body having three internal chambers including a middle chamber having internal side wall located in a predetermined spaced manner from a central electrode of said spark plug, a bottom chamber located at a bottom portion of said metal body, and an upper chamber located above said middle chamber, said three chambers having volumes according to the following formula:
V₁+V₂≦V₃
wherein
V₁ being the volume of said bottom chamber,
V₂ being the volume of said middle chamber, and
V₃ being the volume of said upper chamber
and said side wall of said middle chamber forming a grounding electrode of said spark plug.

2. A high efficiency spark plug according to claim 1 wherein said central electrode has a spark electrode located at a bottom end therein and is positioned in a predetermined space manner from side walls of said middle chamber.

3. A high efficiency spark plug according to claim 2 wherein said spark electrode is recessed from a bottom end of said spark plug.

4. A high efficiency spark plug according to claim 3 wherein said central electrode is mounted on a cylindrical ceramic carrier having a frusto-conical lower end portion extending into said upper chamber.
